(19) United States
(12) Patent Application Publication
(10) Pub. No.: US 2016/0173724 A1
(43) Pub. Date: Jun. 16, 2016

(54) PRINTING APPARATUS, PRINTING METHOD, PROGRAM, AND IMAGE PROCESSING APPARATUS

(71) Applicant: SEIKO EPSON CORPORATION, Tokyo (JP)

(72) Inventors: Toshiaki KAKUTANI, Shiojiri (JP); Satoshi YAMAZAKI, Matsumoto (JP); Masashi KUWABARA, Matsumoto (JP)

(21) Appl. No.: 14/969,476

(22) Filed: Dec. 15, 2015

(30) Foreign Application Priority Data
Dec. 16, 2014 (JP) 2014-253889

(51) Int. Cl. H04N 1/405; B41J 2/21; H04N 1/60

(52) U.S. Cl. CPC H04N 1/4052; H04N 1/60; B41J 2/2103

(57) ABSTRACT

Provided is a printing apparatus which prints by performing a halftoning process, by setting a block which is formed of a plurality of pixels as a unit, the apparatus including a first determination unit which determines whether or not a gradation value of each of the plurality of pixels satisfies a predetermined condition; a second determination unit which applies different conditions based on a determination result of the first determination unit, and determines whether or not to form a dot in at least one of the plurality of pixels; an error calculation unit which performs a calculation of a gradation error which occurs due to a determination result of the second determination unit, and a distribution of the calculated error to an unprocessed pixel by setting the block as a unit; and a dot forming unit which performs forming of dots using the determination result of the second determination unit.

This application claims priority to Japanese Patent Application No. 2014-253889 filed on Dec. 16, 2014. The entire disclosure of Japanese Patent Application No. 2014-253889 is hereby incorporated herein by reference.

### BACKGROUND

1. Technical Field

The present invention relates to a technology of processing an image using image data, and a technology of printing an image.

2. Related Art

As a half toning process in which multi-gradation image data is printed using dot data with a small number of gradations, an error diffusion method in which a density error when gradation number conversion is performed is distributed to peripheral pixels, a systematic dither method in which dot data is generated using a dither mask in which a threshold value arrangement with good dispersibility is performed, or the like, has been known. In addition, also a method in which a property which is close to a result of a halftoning process using the error diffusion method, and a property which is close to a result of a halftoning process using a dither method are expressed according to a gradation value of an image, by combining advantages of the error diffusion method and the dither method has been proposed (refer to JP-A-2011-66594 below). The method which is described in JP-A-2011-66594 is a method in which the advantage of the error diffusion method, and the advantage of the dither method are skillfully combined, and which is excellent in terms of reproducibility of an image in a lower gradation region while taking advantage of the rapidity of the dither method.

Because the above method includes the error diffusion method as a part thereof, it is necessary to calculate error diffusion. The calculation amount of the error diffusion increases when a range of scattered pixels is large or the number of pixels is large. When the calculation amount increases, it takes time to perform processing, and there is a concern that the time necessary for an error calculation may become a bottleneck in a case where printing speed is increased by increasing the number of pixel forming elements (for example, nozzles which eject ink), or the like. In the related art, as a method of suppressing an increase in the calculation amount in such an error diffusion method, a technology in which an error calculation is performed by setting a block in which a plurality of pixels (for example, 2×2 pixels) are put together as a unit has been known (for example, JP-A-2003-283828).

However, in a process using units of blocks, a problem in that a regular dot arrangement occurs in a specific input gradation has been pointed out. In JP-A-2003-283828, in order to prevent the occurrence of a regular dot arrangement, the generation history of dots in a block is detected so that dot generation is not continuous at the same position. Such a detection of history, and control of dot arrangement accompanying the detection become complicated, and this may lead to a decrease in processing speed.

In this manner, when executing high speed image processing while taking advantage of the error diffusion method and the dither method in halftoning technology, there still is room for improvement. For example, in recent years, a technology of providing specific noise characteristics (for example, blue noise characteristics) to a dot arrangement has been made by devising a dither mask; however, there is a need for a halftoning process in which reproducibility of a thin line is sufficiently secured, and high speed processing is executed. In addition, in image processing or printing, miniaturization of apparatuses, cost reduction, energy saving, ease of manufacturing, improvement in the ease of use, and the like, are challenges which are always being pursued.

### SUMMARY

The invention can be realized in the following aspects.

(1) According to a first aspect of the invention, there is provided a printing apparatus which prints an image by performing a half toning process, by setting a block which is formed of a plurality of pixels as a unit. The printing apparatus includes a first determination unit which determines whether or not a gradation value of each of the plurality of pixels satisfies a predetermined condition; a second determination unit which applies different conditions based on a determination result of the first determination unit, and determines whether or not to form a dot in at least one of the plurality of pixels; an error calculation unit which performs a calculation of a gradation error which occurs due to a determination result of the second determination unit, and a distribution of the calculated error to an unprocessed pixel by setting the block as a unit; and a dot forming unit which performs forming of dots using the determination result of the second determination unit.

According to the printing apparatus, it is possible to perform printing using a halftoning process in which high speed processing using error diffusion in which a block is set as a unit, and high reproducibility of an image accompanied with the error diffusion are compatible.

(2) In the printing apparatus, in a determination of whether or not the gradation value in the first determination unit satisfies a predetermined condition, when a value corresponding to a gradation value of each pixel in the block is larger than a first threshold value which is a threshold value of a position corresponding to a pixel position among threshold values which are provided as a dither mask, it may be determined that the predetermined condition is satisfied. In this manner, it is possible to make a determination using the first determination unit using a dither mask. A value which is compared to a threshold value of the dither mask may be a gradation value itself of each pixel, or may be a value which is obtained by performing a predetermined operation with respect to the gradation value. As the operation, addition and subtraction of a predetermined value, multiplication of a predetermined coefficient, or the like, is taken into consideration. In this manner, it is possible to control a determination result of the second determination unit using a comparison with a threshold value, that is, a proportion of on-off of a dot, even when the same threshold value of the dither mask is used. Meanwhile, when providing various characteristics to the dither mask, it is possible to provide the characteristics, for example, blue noise characteristics or green noise characteristics to a generated dot.

(3) In the printing apparatus, in the first determination unit, when a gradation value of at least one pixel in the block satisfies the predetermined condition, a dot corresponding to the pixel may be formed without making the determination using the second determination unit. In this manner, a dot is formed in a pixel of which a gradation value satisfies a predetermined condition in the first determination unit, and when the predetermined condition is satisfied, it is possible to save a trouble of determining whether or not to form a dot again in the second determination unit.

(4) In the printing apparatus, in the first determination unit, when it is determined that a gradation value of any pixel in the block does not satisfy the predetermined condition, the second determination unit may determine whether or not to form a dot by comparing image data which corresponds to a gradation value of a pixel in the block, and which is correction image data that has received a distribution of the calculated error with a second threshold value which is a threshold value prepared for error diffusion. In this manner, when it is determined that a gradation value of any pixel in the block does not satisfy the predetermined condition in the first determination unit, it is possible for the second determination unit to determine forming of a dot using the error diffusion method.

(5) In the printing apparatus, a proportion in which it is determined that a predetermined condition is satisfied, in the first determination unit, may be a proportion which is lower than a proportion in which a dot is finally formed in a gradation value of the pixel. In this case, it is possible to correct a gradation error due to an additional formation of a dot in error diffusion.

(6) In the printing apparatus, the second determination unit may set a proportion in which forming of a dot in a pixel in the block is determined to be less than a half of the number of pixels which belong to the block. In this manner, it is possible to suppress forming of a dot which is necessary for preventing an interruption of a thin line, and to suppress a density error.

(7) In the printing apparatus, when a gradation value of each of the pixels satisfies the predetermined condition, the second determination unit may make the determination by applying a condition in which it is easy to form a dot corresponding to the pixel, compared to a case in which the predetermined condition is not satisfied, and when a gradation value of each of the pixels does not satisfy the predetermined condition, the second determination unit may make the determination by applying a condition in which it is difficult to form a dot corresponding to the pixel compared to the case in which the predetermined condition is satisfied. In this manner, it is possible to perform forming of a dot using error diffusion by determining easiness of dot forming using a determination result in the first determination unit.

(8) In the printing apparatus, when determining forming of a dot compared to a second threshold value which is a threshold value prepared for error diffusion, the second determination unit may determine forming of a dot in any one of a pixel at a predetermined position in the block, a pixel which is randomly determined in the block, and a pixel at a position corresponding to a threshold value with a smallest value among threshold values which are provided in a dither mask, and correspond to pixel positions in the block. In this manner, it is possible to easily determine a position at which a dot is formed.

(9) In the printing apparatus, in the half toning process, multivalue processing of ternary processing or more may be performed based on a determination result of the first determination unit. In this manner, it is possible to perform multivalue processing of ternary processing or more, and to upgrade a quality of a printed matter.

(10) In the printing apparatus, the first determination unit may determine multivalue processing of ternary processing or more by continuously using a plurality of threshold values corresponding to a pixel in the block of the dither mask. In this manner, it is possible to perform multivalue processing of ternary processing or more using a dither mask which is developed for binarization as is.

(11) In the printing apparatus, in the half toning process, the second determination unit may determine whether or not to form a dot with respect to a dot with low density. By doing so, there is no generation of a dot with high density which deteriorates graininess. In this case, when it is possible to form a dot of a plurality of types, a determination of dot forming may be made with respect to only a smallest dot or a dot with lowest density. It is possible to minimize a deterioration in graininess due to a generation of a dot.

(12) According to a second aspect of the invention, there is provided a printing method in which an image is subjected to a halftoning process by setting a block which is formed of a plurality of pixels as a unit, and is printed. The method includes making a first determination which is a determination as to whether or not a gradation value of each of the plurality of pixels satisfies a predetermined condition; making a second determination in which different conditions based on a determination result of the first determination are applied, and whether or not to form a dot in at least one of the plurality of pixels is determined; performing a calculation of a gradation error which occurs due to a determination result of the second determination, and a distribution of the calculated error to an unprocessed pixel by setting the block as a unit; and performing forming of a dot using a determination result of the second determination. By doing so, it is possible to perform printing using a halftoning process in which high speed processing using error diffusion in which a block is set as a unit, and high reproducibility of an image accompanied with the error diffusion are compatible.

(13) According to a third aspect, there is provided an image processing apparatus in which an image is subjected to a halftoning process by setting a block which is formed of a plurality of pixels as a unit. The image processing apparatus includes a first determination unit which determines whether or not a gradation value of each of the plurality of pixels satisfies a predetermined condition; a second determination unit which applies different conditions based on a determination result of the first determination unit, and determines whether or not to form a dot in at least one of the plurality of pixels; and an error calculation unit which performs a calculation of a gradation error which occurs due to a determination result of the second determination unit, and a distribution of the calculated error to an unprocessed pixel by setting the block as a unit. In this manner, it is possible to perform a half toning process in which high speed processing using error diffusion in which a block is set as a unit, and high reproducibility of an image accompanied with the error diffusion are compatible.

(14) According to a fourth aspect, there is provided a program in which an image is subjected to a halftoning process by setting a block which is formed of a plurality of pixel as a unit. The program causes a computer to execute a function of making a first determination which is a determination as to whether or not a gradation value of each of the plurality of pixels satisfies a predetermined condition; a function of making a second determination in which different conditions based on a determination result of the first determination are applied, and whether or not to form a dot in at least one of the plurality of pixels is determined; and a function of performing a calculation of a gradation error which occurs due to a determination result of the second determination, and performing a distribution of the calculated error to an unprocessed pixel by setting the block as a unit.

All of plurality of constituent elements which are included in each of the above described aspects of the invention are not essential, and it is possible to appropriately perform a modification, a deletion, a substitution with another new constituent element, and a partial deletion of limited contents with respect to a part of the plurality of constituent elements in order to solve a part, or all of the above described problems, or to obtain a part, or all of effects which are described in the specification. In addition, it is also possible to configure an independent aspect of the invention by combining a part, or all of technical characteristics which are included in an aspect of the invention which is described above with a part, or all of technical characteristics which are included in another aspect of the invention which is described above, in order to solve a part, or all of the above described problems, or to obtain a part, or all of effects which are described in the specification.

It is also possible to execute the invention in various forms other than a printing apparatus, or an image data processing device. For example, it is possible to execute the invention in a form of a manufacturing method, or a control method of a printing apparatus, a computer program for executing the control method, a recording medium which is non-transitory in which the computer program is recorded, or the like.

### BRIEF DESCRIPTION OF THE DRAWINGS

The invention will be described with reference to the accompanying drawings, wherein like numbers reference like elements.

FIG. 1 is a schematic configuration diagram of a printer as a first embodiment of the invention.

FIG. 2 is a flowchart which illustrate a flow of a printing process in the printer.

FIG. 3 is a flowchart which illustrates a flow of a halftoning process as the first embodiment.

FIGS. 4A and 4B are an explanatory diagrams which illustrate a dither mask which is used in the embodiment.

FIG. 5 is a flowchart which illustrates a routine of a first determination process according to the first embodiment.

FIGS. 6A to 6C are explanatory diagrams which illustrate a relationship between a block and a pixel.

FIG. 7 is an explanatory diagram which illustrates noise characteristics which are included in the dither mask which is used in the embodiment.

FIGS. 8A to 8C are explanatory diagrams which illustrate an example of a first determination process.

FIG. 9 is a flowchart which illustrates a routine of a second determination process according to the first embodiment.

FIG. 10 is an explanatory diagram which illustrates a proportion of error diffusion between blocks.

FIG. 11 is a flowchart which illustrates a routine of a second determination process as modification example 1 of the first embodiment.

FIG. 12 is a graph which illustrates an example of a threshold value in modification example 1.

FIG. 13 is a graph which illustrates another example of the threshold value in modification example 1.

FIG. 14 is an explanatory diagram which illustrates a relationship between a pixel of an input image and a pixel of an output image according to a second embodiment.

FIG. 15 is a graph which exemplifies a relationship between an input gradation value and data items of large, medium, and small which denote a proportion of forming dots of large, medium, and small according to the second embodiment.

FIG. 16 is a flowchart which illustrates a routine of a first determination process according to the second embodiment.

FIG. 17 is a flowchart which illustrates a routine of a second determination process according to the second embodiment.

### DESCRIPTION OF EXEMPLARY EMBODIMENTS

### A. First Embodiment

A first embodiment of the invention will be described.

### A-1. Configuration of Apparatus

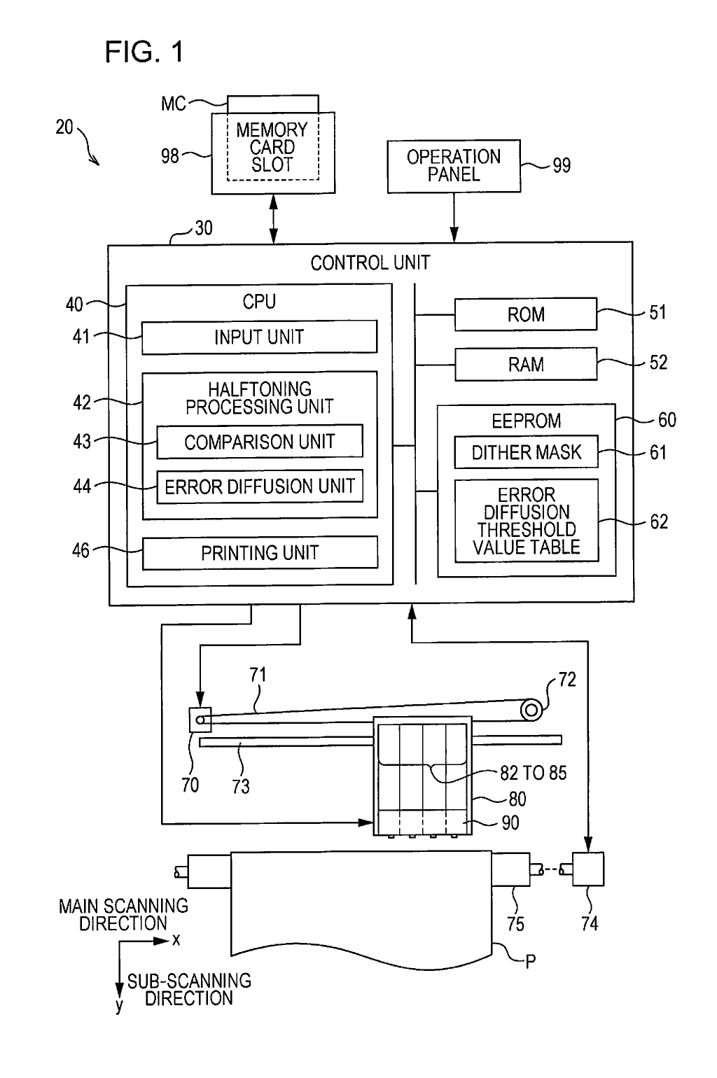

FIG. 1 is a schematic configuration diagram of a printer 20 as the first embodiment of a printing apparatus of the invention. The printer 20 is a serial ink jet printer which performs bidirectional printing, and as illustrated, the printer 20 is formed of a mechanism which transports a printing medium P using a sheet feeding motor 74, a mechanism which causes a carriage 80 to reciprocate in an axial direction of a platen 75 using a carriage motor 70, a mechanism which performs ejecting of ink and forming of dots by driving a printing head 90 which is mounted on the carriage 80, and a control unit 30 which controls the exchange of signals of the sheet feeding motor 74, the carriage motor 70, the printing head 90, and an operation panel 99.

The mechanism which causes the carriage 80 to reciprocate in the axial direction of the platen 75 is formed of a sliding shaft 73 which is installed in parallel to a shaft of the platen 75, and holds the carriage 80 in a slidable manner, a pulley 72 over which an endless driving belt 71 is stretched between the carriage motor 70 and the pulley 72, and the like.

Ink cartridges 82 to 85 for color ink in which, as color ink, cyan ink C, magenta ink M, yellow ink Y, and black ink K are respectively accommodated are mounted on the carriage 80. Nozzle columns which correspond to the above described color inks are formed in the printing head 90 on the lower part of the carriage 80. When these ink cartridges 82 to 85 are mounted on the carriage 80 from above, it is possible to supply ink to the printing head 90 from each cartridge. In addition, six color inks may be used by adding light cyan ink Lc, and light magenta ink Lm to the above described four color inks.

The control unit 30 is formed of a CPU 40, a ROM 51, a RAM 52, and an EEPROM 60 which are connected to each other through the bus. The control unit 30 controls the entire operation of the printer 20 by loading a program which is stored in the ROM 51 or the EEPROM 60 in the RAM 52, and executing the program, and also functions as an input unit 41, a halftoning processing unit 42, and a printing unit 46. The function of the halftoning processing unit 42 includes the functions of a comparison unit 43 which corresponds to a subordinate concept of a first determination unit, and an error diffusion unit 44 which corresponds to a subordinate concept of a second determination unit. A dither mask 61 and an error diffusion threshold value table 62 are stored in the EEPROM 60. The half toning process or the dither mask 61 which is used in the halftoning process will be described later in detail. The error diffusion threshold value table 62 is not particularly used in the first embodiment; however, the error diffusion threshold value table is illustrated as a table which is also present in the EEPROM 60, since the table is used in a modification 1 thereof. The contents thereof will be described in detail in modification example 1.

A memory card slot 98 is connected to the control unit 30, and it is possible to input image data ORG by reading the image data from a memory card MC which is inserted into the memory card slot 98. According to the embodiment, the image data ORG which is input from the memory card MC is data which is formed of color components of three colors of red (R), green (G), and blue (B).

The printer 20 with the above described hardware configuration causes the printing head 90 to reciprocate in the main scanning direction with respect to the printing medium P by driving the carriage motor 70, and moves the printing medium P in the sub-scanning direction by driving the sheet feeding motor 74. The control unit 30 forms ink dots of appropriate color at an appropriate position on the printing medium P by driving a nozzle at an appropriate timing based on printing data in accordance with a reciprocating movement (main scanning) of the carriage 80, or a printing medium feeding movement (sub-scanning). In this manner, the printer 20 can print a color image which is input from the memory card MC on the printing medium P.

### A-2. Printing Process:

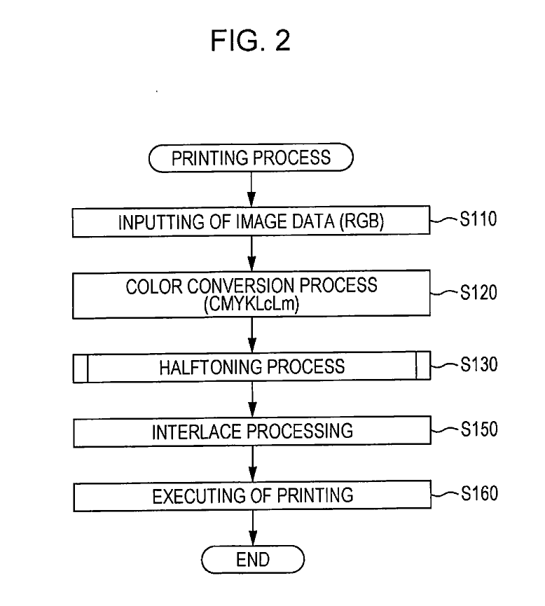

A printing process in the printer 20 will be described. FIG. 2 is a flowchart which illustrates a flow of a printing process in the printer 20. The printing process, here, is started when a user performs an operation of instructing printing with respect to a predetermined image which is stored in the memory card MC using the operation panel 99, or the like. When the printing process is started, first, the CPU 40 reads the image data ORG of an RGB format which is a printing target from the memory card MC through the memory card slot 98, and inputs the image data as a process of the input unit 41 (step S110).

When the image data ORG is input, the CPU 40 performs color conversion with respect to the image data ORG so that the image data is changed from the RGB format to a CMYKLcLm format with reference to a lookup table (not illustrated) which is stored in the EEPROM 60 (step S120). In addition, resolution conversion may be performed as necessary, before and after the color conversion process.

When the color conversion process is performed, the CPU 40 performs a halftoning process in which image data is converted into dot data in which the on-off state of a dot of each color is determined for each pixel, as a process of the halftoning processing unit 42 (step S130). A detail of the halftoning process, here, will be described later. In addition, in the specification, the “halftoning process” is not limited to binarization processing which relates to the on-off state of a dot, and means general gradation number conversion (reduction) processing including multivalue processing which relates to the on-off state of a large dot and a small dot. In addition, image data which is used in step S130 may be subjected to image processing such as a resolution conversion process or a smoothing process.

When the halftoning process is performed, the CPU 40 performs interlace processing in which an arrangement of dots which are subjected to the halftoning process is rearranged into an arrangement of data of a dot pattern which is formed in a unit of one main scanning in accordance with a nozzle arrangement, or a sheet feeding amount in the printer 20 (step S150). When the interlace processing is performed, the CPU 40 drives the printing head 90, the carriage motor 70, the sheet feeding motor 74, and the like, and executes printing as a process of the printing unit 46 (step S160).

### A-3. Outline of Halftoning Process:

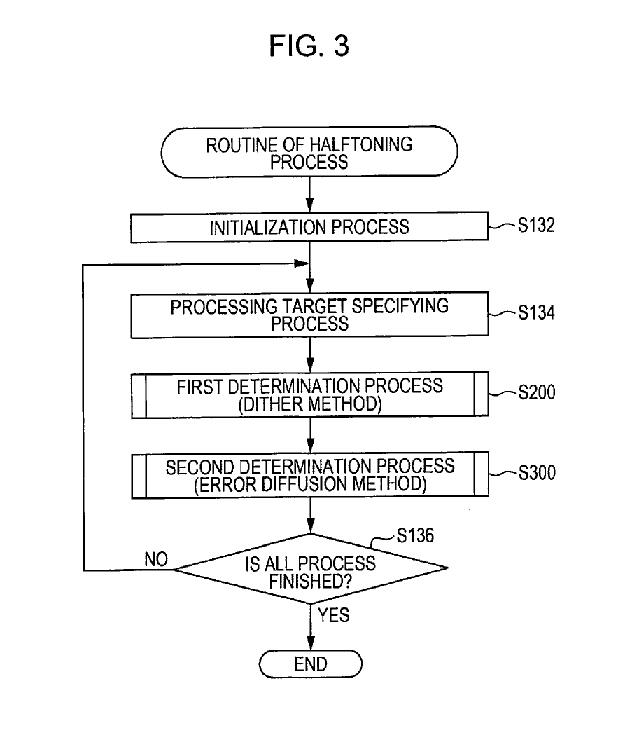

The above described halftoning process (step S130) will be described with reference to FIG. 3. As illustrated, when the process is started, the CPU 40 sequentially executes an initialization process (step S132), a processing target specifying process (step S134), a first determination process (step S200), a second determination process (step S300), and a process of determining whether or not all of processes have been completed (step S136)′.

An outline of the halftoning process will be described. The initialization process is a process in which variables, or the like, which are necessary in the halftoning process are initialized. For example, a process in which variables (x, y) which denote a pixel position are initialized so as to be (0, 0), or the like, is included in order to set a pixel position at which the process is started to an upper left side of an image.

When the initialization process is finished, subsequently, the processing target specifying process is executed (step S134). The processing target specifying process is a process in which a processing target is updated every time the first determination process (step S200) and the second determination process (step S300), which will be described later, are executed, since the halftoning process is sequentially executed with respect to all of the pixels.

After a block as a processing target is specified by executing the processing target specifying process, the first determination process is performed with respect to four pixels which are included in the target block (step S200). The determination process is a process in which a difference in size between a threshold value which is prepared as the above described dither mask 61 and image data in each pixel is determined using a so-called dither method with respect to each pixel.

When the first determination process (step S200) is finished, subsequently, the second determination process (step S300) is performed using a result of the first determination process. The second determination process is a process in which forming of a dot is finally determined. In the second determination process, a difference in size between the threshold value for error diffusion and image data of the entire block is determined by applying a so-called error diffusion method, and whether or not to form a dot is determined, using also the result of the first determination process.

Thereafter, whether or not the halftoning process with respect to all of the blocks and pixels which belong to the blocks has finished is determined (step S136), and the process in FIG. 3 is repeated until the process is finished. Accordingly, when it is determined that the process has not finished, the process returns to step S134, a block as a processing target is updated, and the first and second determination processes are repeated. The processes which are repeatedly executed, that is, the initialization process (step S132), the processing target specifying process (step S134), and the first and second determination processes (steps S200 and S300) will be described later in detail.

### Initialization Process

The initialization process (step S132) which is performed by the CPU 40 is a process in which variables which are necessary for the halftoning process are initialized. The following are the variables which are initialized.

(1) Pixel position (x, y): The position of a pixel of an image which is to be processed at the start of processing is initialized so as to be (0, 0) on an upper left side of the image, that is, by setting a main scanning direction to x, and a sub-scanning direction to y.

(2) Block number (Bnx, Bny): According to the embodiment, the process is performed by setting four pixels of 2 pixels×2 pixels in total to one block. The block number is set to an initialization value (0, 0). The relationship between block number and pixel position will be described later.

(3) Position of threshold value on dither mask (xm, ym): These are variables which denote a reading position at which a threshold value is stored in the dither mask 61. The variables (xm, ym) are initialized so as to be (0, 0).

(4) Value of diffused error ed[Bnx, Bny] in each block: According to the embodiment, since a density error which occurs depending on whether or not a dot is formed is diffused to a peripheral block by setting a block as a unit, a buffer for storing the diffused error is included in each block. In the initialization process, all of the values of the buffer are set to zero.

(5) Result value Result [x, y]: A determination result using the first determination process (step S200) is denoted with respect to a pixel at a position of (x, y). All of the result values are set to zero.

(6) An output buffer OUT [x, y] which denotes whether or not a dot is formed is initialized so as to be a value zero which denotes an off state of a dot.

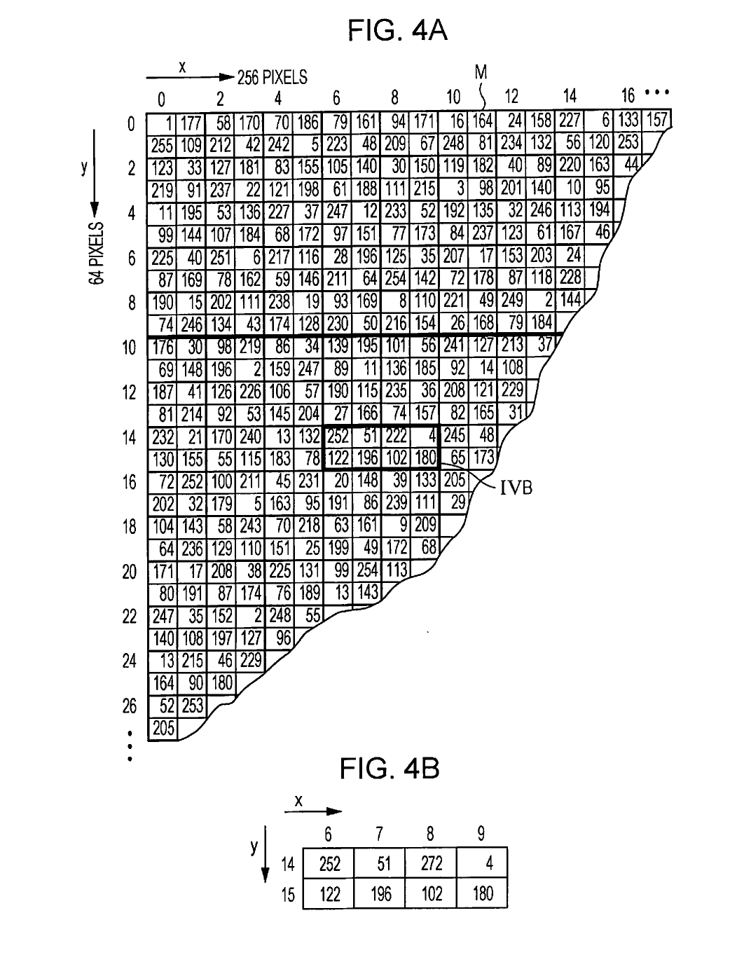

In the half toning process, a gradation value of a pixel at a position (x, y) is denoted by data[x, y]. Since the gradation value is denoted by 8 bits, a gradation value of a pixel has values of 0 to 255. In addition, as illustrated in FIG. 4A, the dither mask 61 which is used in the first determination process which will be described later has a magnitude of 256 pixels in the main scanning direction, and 64 pixels in the sub-scanning direction. According to the embodiment, also a threshold value THn_d which is stored in each position of the dither mask 61 is denoted by 8 bits, and the threshold value has values of 1 to 255. A frame of a thick line in FIG. 4A corresponds to a block of 2 pixels×2 pixels. In addition, for ease of explanation, all of the vertical and horizontal dimensions of an image, vertical and horizontal dimensions of the dither mask, and the like, are treated as even numbers.

### Processing Target Specifying Process

When the initialization process (step S132) is finished, subsequently, the processing target specifying process (step S134) is performed. According to the embodiment, the halftoning process is performed by setting a block which is formed of 2 pixels×2 pixels as a unit. The halftoning process is performed by sequentially moving the position of a block which will be processed in the main scanning direction (x direction) from a block (0, 0) on the upper left side of an image, and when the process is performed up to the right end in the main scanning direction, the position is moved in the sub-scanning direction (y direction), and the process is sequentially performed again from the left end. A row of pixels, the positions of which in the sub-scanning direction are the same, is also referred to as a “raster”. Since the process is performed in units of blocks, the halftoning process according to the embodiment is performed by two rasters at a time. When processing of a row of one block (two rasters) is finished, the process moves to processing of a row of the subsequent block (two rasters). For this reason, in the following descriptions, the position of a block, and the position of a pixel in the process are denoted in the order of (y, x), differently from the usual display of coordinates. In addition, there is a case in which the position of the pixel is denoted using a block number Bn. Both of a start position of a block (0, 0) and a start position of a pixel (0, 0) are located on the upper left side of an image. For this reason, the relationship between block number and pixel position becomes y=2·Bny, and x=2·Bnx, when exemplifying a pixel on the upper left side of each block.

In the processing target specifying process (step S134), first, a block number which includes a pixel which will be subjected to the halftoning process is specified. The initialization value of the block number (Bny, Bnx) is (0, 0), and when a halftoning process of four pixels which are included in one block is finished, the block position is advanced in the main scanning direction (Bnx←Bnx+1), and when processing for two rasters is finished, the block position in the main scanning direction is initialized (Bnx←0), and the block position in the sub-scanning direction is advanced by one (Bny←Bny+1). When a block as a processing target is specified, subsequently, pixel data in the block is specified. The process is a process in which four pixels which are included in a block which will be processed, that is, image data of a block which is formed of four pixels of (y, x), (y, x+1), (y+1, x), and (y+1, x+1), when setting (y, x) as a reference position, is decided. The positions of four pixels can be denoted as follows when the block number (Bny, Bnx) is used.

(y,x)=(2·Bny,2·Bnx)

(y,x+1)=(2·Bny,2·Bnx+1)

(y+1,x)=(2·Bny+1,2·Bnx)

(y+1,x+1)=(2·Bny+1,2·Bnx+1)

In addition, image data which denotes a gradation value of a pixel at each position is denoted as data[y, x]. Accordingly, image data items data[Bny, Bnx] of all of the blocks in which four pixels to be processed are included are denoted by data[Bny, Bnx]=data[y, x]+data[y, x+1]+data[y+1, x]+data[y+1, x+1]+ed[Bny, Bnx]. As described in the initialization process, ed[Bny, Bnx] is a gradation error which is diffused from a peripheral processed block with respect to a block as a target of the halftoning process. There is a case in which the gradation error is diffused from a plurality of blocks, and a value thereof can be either a positive value or a negative value. Accordingly, ed[Bny, Bnx] corresponds to a total sum of errors which are diffused from the peripheral block by that time, at a processing time point. In addition, in the final processing target specifying process, a counter Con in which a determination result in the first determination process is counted is set to a value of zero. In this manner, the processing target specifying process is finished.

### First Determination Process

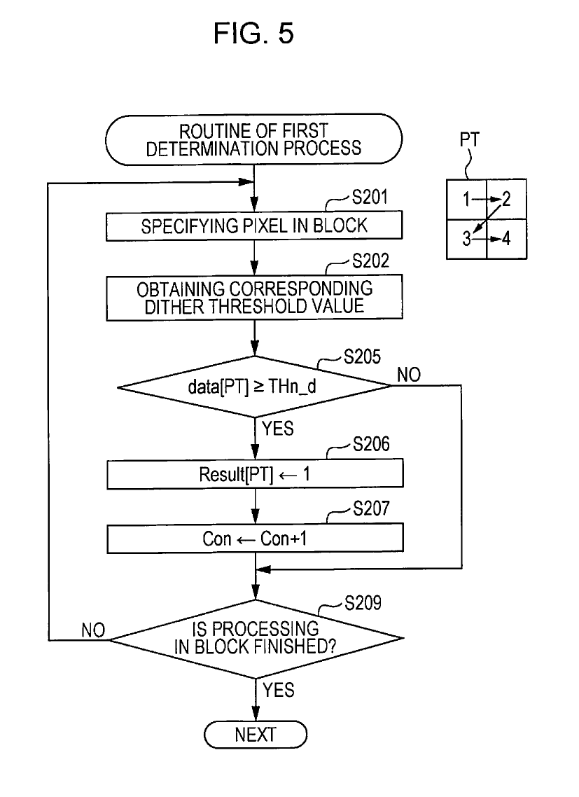

After finishing specifying of a block as a processing target, the first determination process is performed (step S200). A detail of the process is illustrated in FIG. 5. When the first determination process is started, first, the CPU 40 performs a process of specifying a pixel in the block (Bny, Bnx) (step S201). In each block, 2×2 pixels, that is, four pixels are included. Since the process is sequentially performed with respect to the four pixels in the block, a pixel is specified according to a predetermined order.

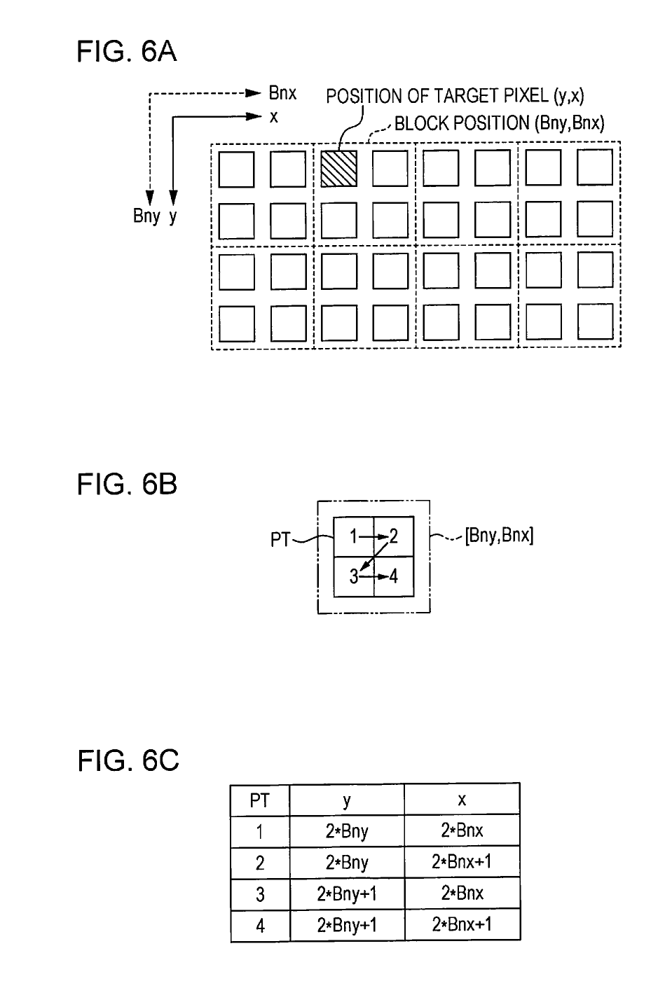

A relationship between a block and a pixel is illustrated in FIGS. 6A to 6C. FIG. 6A illustrates a relationship between the block position (Bny, Bnx) and the pixel position (y, x). In addition, FIG. 6B illustrates processing order of 2×2 pixels which are included in one block. The order is order of the upper left side (PT=1), the upper right side (PT=2), the lower left side (PT=3), and the lower right side (PT=4) in the block. In the following descriptions, a pixel is specified using the mark PT; however, as illustrated in FIG. 6C, correspondences to actual pixel positions become

PT=1:(y,x)=(2·Bny,2·Bnx)

PT=2:(y,x+1)=(2·Bny,2·Bnx+1)

PT=3:(y+1,x)=(2·Bny+1,2·Bnx)

PT=4:(y+1,x+1)=(2·Bny+1,2·Bnx+1).

When the pixel is specified according to the order, subsequently, a process of obtaining the threshold value THn_d from a corresponding dither mask is performed (step S202). A position (ym, xm) of threshold value which corresponds to a pixel which will be processed is obtained as ym=mod(y, 64), and xm=mod(x, 256). Here, a function mod (a, b) is a function which means a remainder when a value a is divided by a value b. The number 64 is a magnitude of the dither mask 61 in the y direction, and the number 256 is a magnitude of the dither mask 61 in the x direction.

A plurality of the threshold values THn_d corresponding to a first threshold value are arranged in the dither mask 61. The first threshold value THn_d (hereinafter, also referred to as threshold value THn_d in simple) corresponds to a subordinate concept of the “first threshold value” in the application. According to the embodiment, the threshold value THn_d is values from 1 to 255. In each of the threshold values THn_d, a spatial frequency of a dot which is formed by being compared with the threshold value is arranged so as to be so-called blue noise characteristics.

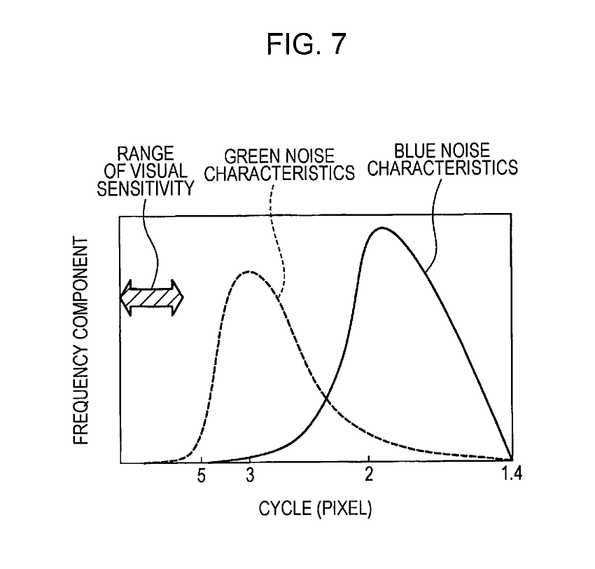

FIG. 7 is an explanatory diagram which exemplifies noise characteristics which are included in such a dither mask 61. In the figure, spatial frequency characteristics of a threshold value which is set in each pixel of the dither mask which has blue noise characteristics and green noise characteristics are conceptually illustrated. The blue noise characteristics in the dither mask are characteristics which has the largest frequency component in a high frequency domain, and for example, when dot density is approximately 50%, the characteristics have the largest frequency component in a high frequency domain in which a length of one cycle is approximately two pixels. It means that a storing position of a threshold value is adjusted so that the largest frequency component is generated in the high frequency domain in consideration of a human visual property with low sensitivity in the high frequency domain. When dots are generated using the dither mask which has such blue noise characteristics, it is possible to obtain an image which is excellent in diffusivity of a dot.

In addition, FIG. 7 exemplifies the green noise characteristics as a dashed curve. As illustrated, the green noise characteristics have the largest frequency component on the slightly low frequency side compared to the blue noise characteristics, and when a pixel size is sufficiently small, it is also possible to obtain a good image in which there is no granular feeling even in the green noise characteristics. The dither mask 61 is set so as to have predetermined spatial frequency characteristics such as the blue noise characteristics, or the green noise characteristics.

In addition, according to the embodiment, the dither mask 61 has predetermined dot forming characteristics. That is, a dot pattern of a dot group which is formed due to an outward movement of the carriage 80, a dot pattern of a dot group which is formed due to a return movement in the bidirectional printing, and dot patterns of all of dot groups in which the above described dot patterns are put together have the blue noise characteristics. The technology is disclosed, for example, in JP-A-2007-15359. In addition, the dither mask 61 may have the blue noise characteristics in each main scanning group which denotes that, at which main scanning operation a dot is formed, among a plurality of main scanning operations of the carriage 80, instead of the above described groups in each of the outward movement and the return movement, or in addition to those.

In this manner, when specifying of a pixel which will be processed (step S201), and obtaining of a threshold value THn_d (step S202) corresponding to a pixel position thereof are finished, subsequently, a process of determining a size between an image data data[PT] of the pixel and the threshold value THn_d is performed (step S205).

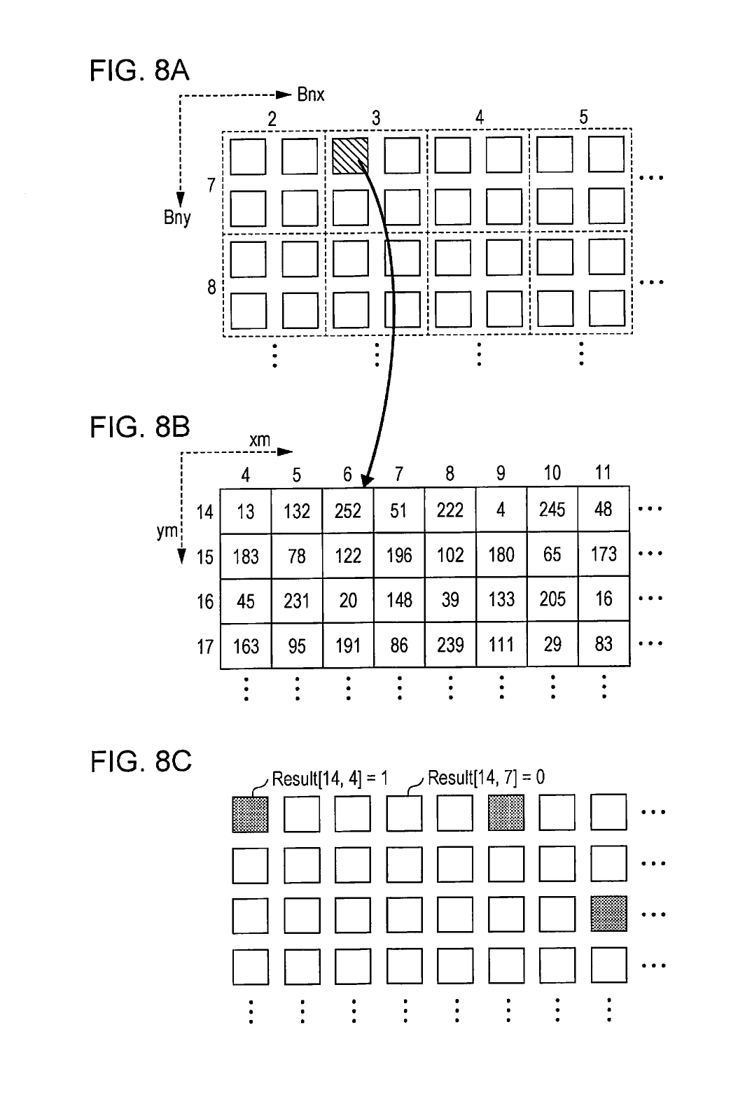

FIGS. 8A to 8C are explanatory diagrams for explaining a determination in step S205. In FIG. 8A, in four rasters in total of block numbers Bny 7 and 8 in the y direction, 8 blocks in total (32 pixels) of block numbers Bnx 2 to 5 in the x direction are illustrated. In addition, in FIG. 8B, threshold values of the dither mask 61 which correspond to each pixel position of the 8 blocks, that is, 32 threshold values THn_d in total of numbers in vertical direction ym 14 to 17 of the dither mask, and numbers in horizontal direction xm 4 to 11 are exemplified. The threshold values which are illustrated in FIG. 8B are the same as those which are exemplified in FIG. 4B.

When assuming that a block (Bny, Bnx) which is being processed is (7, 3), and a pixel PT which is being processed is 1, the pixel in FIG. 8A which is hatched, that is, gradation data data[14, 6] of the pixel of which a pixel position (y, x) is (2·Bny, 2·Bnx)=(14, 6) and a threshold value 252 of a position (ym, xm)=(14, 6) corresponding to the dither mask 61 are compared with each other.

When a determination result in step S205 is “Yes”, that is, when gradation data data[PT] of a target pixel is the threshold value THn_d or more, a value 1 is input to a result value Result [PT] (step S206), and the variable Con which counts the number of pixels of which a determination result is “Yes” is increased by a value 1 (step S207).

On the other hand, when the determination in step S205 is “No”, that is, when the gradation data data[PT] of a target pixel is less than the threshold value THn_d, setting of a value with respect to the result value Result [PT] and the variable Con is not performed. Thereafter, a determination whether or not processing with respect to all of pixels in the block are finished is made (step S209), and when the processing are not finished, the process returns to step S201, and the above described processing are repeated.

When processing of a pixel on the upper left side (PT=1) as a pixel PT is finished, subsequently, processing of a pixel on the upper right side (PT=2) is performed. At this time, a pixel position (y, x+1) becomes (2·Bny, 2·Bnx+1)=(14, 7), and gradation data data[14, 7] of the pixel and a threshold value 51 of a position (ym, xm)=(14, 7) corresponding to the dither mask 61 are compared with each other. According to a comparison result, setting of a value of the result value Result [PT], increasing of the variable Con for counting, or the like, is performed as described above.

Similarly, when processing of a pixel on the lower left side (PT=3), and processing of a pixel on the lower right side (PT=4) are finished, a determination in step S209 becomes “Yes”, and the routine of the first determination process is ended.

According to the above described processing, gradation data items of PTs of four pixels which belong to the block are respectively compared with the threshold value THn_d at a position corresponding to the dither mask 61 by setting a block as a unit, and when the gradation data is large, a process of setting a value 1 to the result value Result [PT], and increasing the variable Con for counting by a value 1 is performed. When the determination result is “No”, the result value Result [PT] is maintained at the initial value zero. As a result of a comparison between gradation data and a threshold value, pixels of which the result value Result [PT] is set to a value 1 are exemplified in FIG. 8C by being blackened.

### Second Determination Process

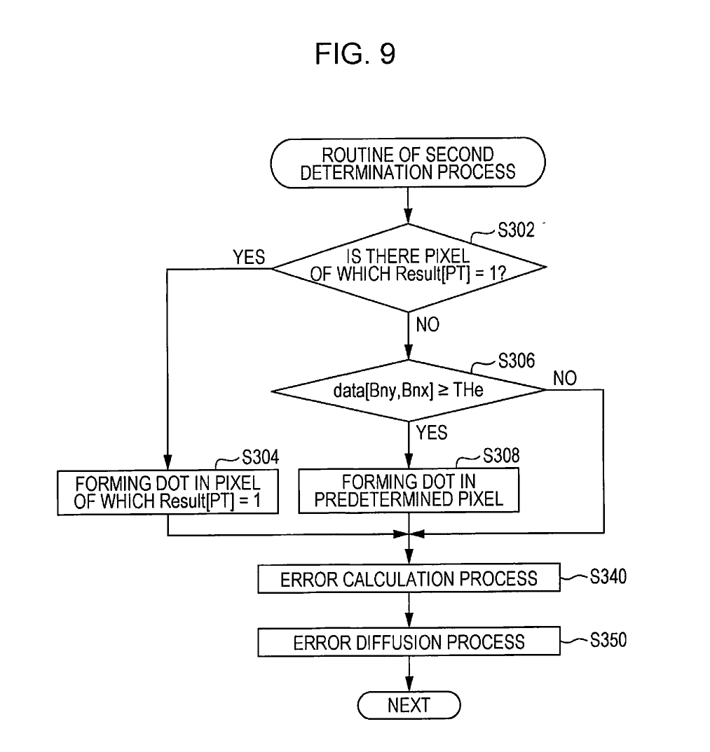

When the above described first determination process is finished, subsequently, the second determination process (step S300 in FIG. 3) is executed. A detail of the process is illustrated in FIG. 9. When a routine of the second determination process which is illustrated in FIG. 9 is started, first, whether or not there is a pixel of which the result value Result [PT] is a value 1 in a block which is being processed is determined (step S302).

When there is a pixel of which the result value Result [PT] is a value 1, forming of a dot in the pixel is determined (step S304). Specifically, a value 1 which denotes forming of a dot is written in the output buffer OUT [PT] which denotes whether or not a dot is formed.

On the other hand, in step S302, when it is determined that there is no pixel of which the result value Result [PT]=1 at all in four pixels in the block, subsequently, a total sum of gradation data in the block, that is, a determination whether or not the data[Bny, Bnx] is the threshold value THe or more, in the error diffusion method, is made (step S306). As described above, since the data[Bny, Bnx] is a value which reflects a density error which is diffused from the peripheral block, the data[Bny, Bnx] is calculated as data[Bny, Bnx]=data[y, x]+data[y, x+1]+data[y+1, x]+data[y+1, x+1]+ed[Bny, Bnx].

The threshold value THe which is used in determining in step S306 corresponds to a subordinate concept of the second threshold value in the application. According to the first embodiment, as will be described later, the second threshold value THe is fixed to a value which is used in normal error diffusion (median value in gradation range). When gradation data data[Bny, Bnx] of the entire block is the threshold value THe or more, it is assumed that a dot is formed in a predetermined pixel in the block, a value 1 which denotes forming of a dot is written in the output buffer OUT [PT] corresponding to a predetermined pixel, and the counter Con is increased by a value 1 (step S308). According to the embodiment, a predetermined pixel is set to a pixel on the upper left side (PT=1) in the block. Originally, a dot may be formed in a pixel which has the largest gradation data among four pixels in the block. The reason for this is that, when a dot is formed in the pixel which has the largest gradation data, a dot is easily formed at a position of which a gradation value is high in the original image data. Alternatively, a dot may be formed in a pixel corresponding to a position of a corresponding dither mask with the smallest threshold value. The reason for this is that, when the threshold value THn_d of the dither mask is small, a dot is easily formed in a corresponding pixel, and it is easy to reflect characteristics of the dither mask 61. In addition, it is allowable to randomly determine a pixel in which a dot is formed.

After the above described processes, an error calculation process (step S340), and an error diffusion process (step S350) are performed. The error calculation process is performed after performing the following processes of

(a) the process in step S304 in which a dot is formed in a pixel in which a value of the result value Result [PT] is 1,

(b) the process in step S308 in which a dot is formed in a predetermined pixel, or

(c) the process in step S306 in which a total sum of image data in a block, that is, data[Bny, Bnx] is determined to be less than the threshold value THe in the error diffusion method, and it is determined that a dot is not formed.

In the error calculation process (step S340), a density error ed[Bny, Bnx] which occurs in a processed block is obtained. The density error ed[Bny, Bnx] is obtained using the following expression.

ed[Bny,Bnx]=data[Bny,Bnx]−Con·ONv

Here, ONv is a value corresponding to a density value which is assumed to be realized in one pixel, when a dot is formed, or is not formed in the pixel. According to the embodiment, a value when a dot is formed is referred to as an on-value, and is set to a value 255. The counter Con denotes the number of dots which are set to be formed in a block. Accordingly, a density error ed[Bny, Bnx] of a processed block becomes a value which is obtained by subtracting a multiplied value of Con which is the number of dots formed in a block and an on-value from total sum data[Bny, Bnx] of image data in a block in a case of (a), becomes a value which is obtained by subtracting an on-value of one dot which is formed in a block from the total sum data[Bny, Bnx] of image data in the block in a case of (b), and becomes the total sum data[Bny, Bnx] of image data in the block in a case of (c).

In the case (c), the reason why the total sum data[Bny, Bnx] of image data in the block which includes a density error which is diffused from the peripheral pixel becomes the density error ed[Bny, Bnx] as is, is that it is assumed that Con·ONv=0, since a dot is not formed. In the cases (a) and (b), there is a case in which an operation result becomes a minus number, and in this case a minus error is diffused to the peripheral pixel.

When density which is executed by a dot formed in a block is upper than that in image data in the entire block, a density error becomes a minus value. When density which is executed by a dot formed in a block is lower than that in image data in the entire block, the density error becomes a plus value. Therefore, the error diffusion process (step S350) in which a density error ed[Bny, Bnx] which is obtained in the following manner is diffused to an adjacent block is executed.

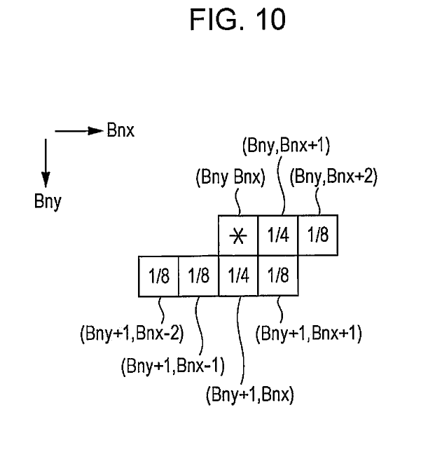

FIG. 10 is an explanatory diagram which illustrates an example of an error diffusion mask. The block (Bny, Bnx) to which a mark * is attached is a target block in which a half toning process is performed. In the block, the error ed[Bny, Bnx] which is calculated in step S340 is diffused to six peripheral blocks. A proportion of distribution is set to ¼ in a block which is next to the target block on the right side (block which is subsequently processed), and a block right below, and is set to ⅛ in four blocks other than those. Specifically, the density error ed[Bny, Bnx] is distributed in a proportion of ¼ with respect to the block (Bny, Bnx+1), a proportion of ⅛ with respect to the block (Bny, Bnx+2), a proportion of ⅛ with respect to the block (Bny+1, Bnx−2), a proportion of ⅛ with respect to the block (Bny+1, Bnx−1), a proportion of ¼ with respect to the block (Bny+1, Bnx), and a proportion of ⅛ with respect to the block (Bny+1, Bnx+1), and the error diffusion is performed.

The density error which is distributed in this manner is maintained after being added to an error diffusion buffer which is prepared in each block, and is used in the second determination process in each block. In this manner the second determination process is finished. Thereafter, whether or not the above described processes are finished with respect to the entire block is determined (step S136 in FIG. 3), and the above described processing target specifying process (step S134), the first determination process (step S200), and the second determination process (step S300) are repeated until the processes with respect to the entire block are finished.

### Effects of First Embodiment

According to the above described first embodiment, it is possible to obtain the following operational effects.

(1) The first determination process using the dither mask is performed before the second determination process. As a result, it is possible to perform a dot arrangement which reflects characteristics of the dither mask 61, since a dot is formed in a pixel of which a gradation value is larger than the threshold value THn_d of the dither mask.

(2) When it is determined in the first determination process that a condition for forming a dot is not established in any of pixel in a block which is being processed, whether or not a condition for forming a dot is established, including also a density error which is diffused from the peripheral block using the error diffusion method, is determined in the second determination process. Accordingly, when it is not determined that a dot is formed at a portion of an image in which a thin line is drawn, or the like, for example, in order for a distribution of a gradation value of the dither mask, a necessary dot is formed using the error diffusion method.

(3) In the above described case (2), it is possible to reduce a calculation process of error diffusion, and to make a processing time short, since the error diffusion process is performed in a unit of block.

(4) In the second determination process, it is possible to suppress, so to speak, the number of dots which is additionally formed, since a dot which is formed in the second determination process is one at most in a block. Modification example 1 of first embodiment

In the above described embodiment, in the first determination process, when a gradation value of any pixel is a threshold value or more at a position corresponding to the dither mask, the result value Result [PT] is set to a value 1, it is determined that a dot is formed in the pixel, and a determination of a size between [PT] and the threshold value THe in the second determination process is not performed. In the second determination process, making the determination of forming a dot using the error diffusion method (step S306 in FIG. 9) is limited to a case in which the result value Result [PT] is not set to a value 1 in any pixel in the first determination process. In contrast to this, in modification example 1, regardless of a result in the first determination process, the determination of a size between [PT] and the threshold value THe is made. Hereinafter, a second determination process in the modification example will be described. In modification example 1, the entire printing process (FIG. 2), the entire halftoning process (FIG. 3), and the first determination process (FIG. 5) are the same as those in the first embodiment.

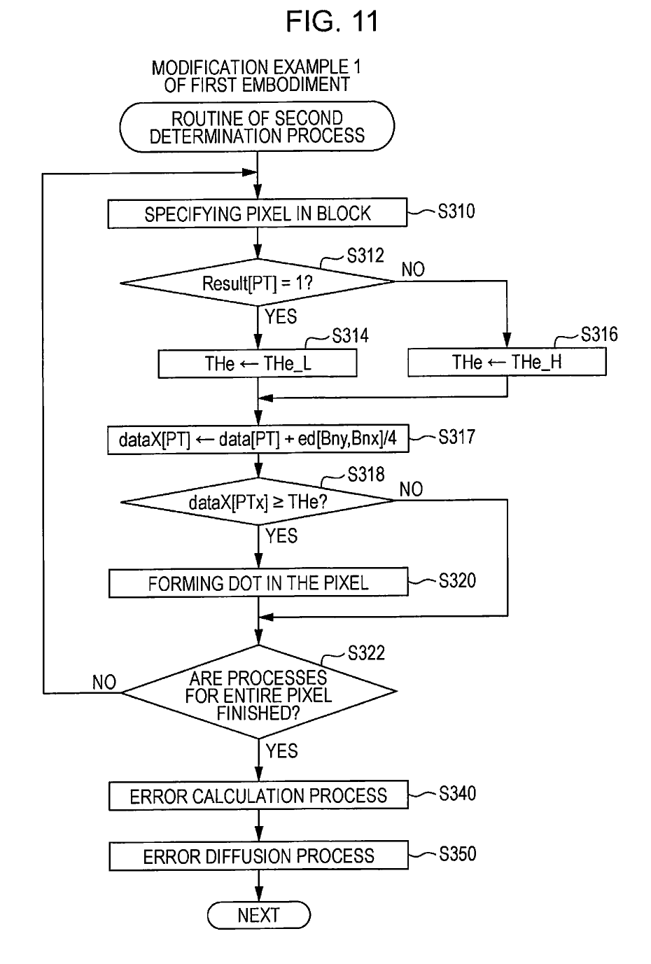

In modification example 1, as a routine of the second determination process, the process which is illustrated in FIG. 11 is executed. In FIG. 11, the same process as the second determination process in the first embodiment will be given the same reference numerals, and detailed descriptions will be omitted. When the routine of the second determination process in modification example 1 is started, first, the CPU 40 performs a process of specifying a pixel in a block (step S310). As illustrated in FIG. 6B, pixels PT in a block are specified in the same order as that in the first determination process.

When a pixel is specified, whether or not a result value Result [PT] of the pixel in the first determination process is a value 1 is determined (step S312). When the result value Result [PT] is a value 1 (Yes in step S312), subsequently, a process of setting a threshold value THe which is a second threshold value THe to a low threshold value THe_L is performed (step S314). On the other hand, when the result value Result [PT] is not a value 1 (No in step S312), a process of setting the threshold value THe to a high threshold value THe_H is performed (step S316).

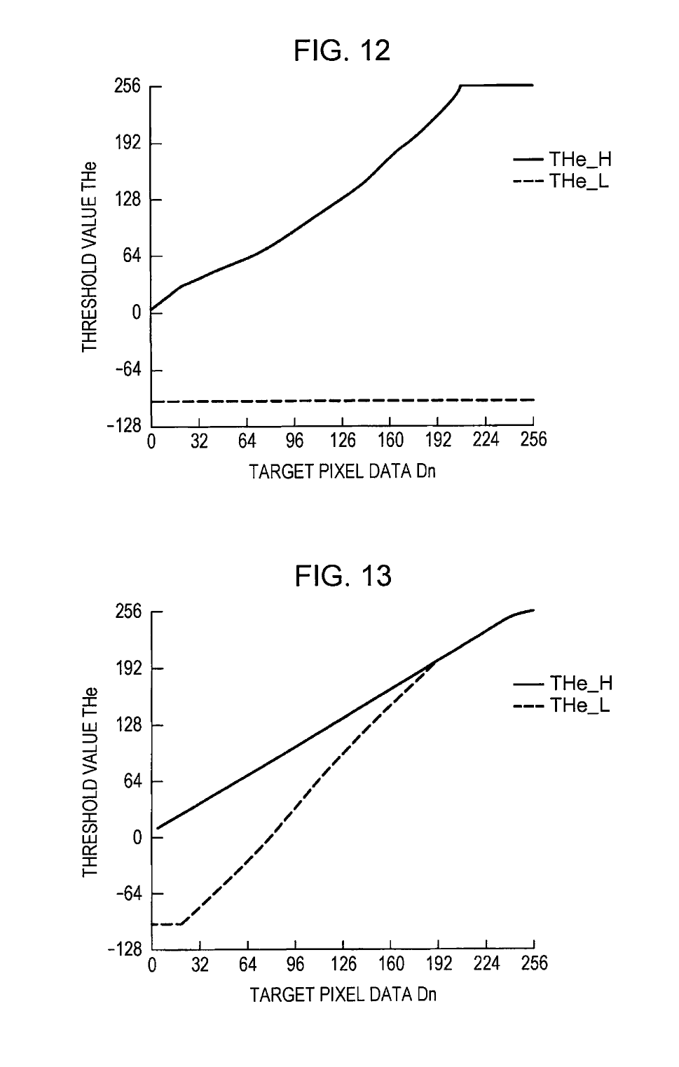

Examples of the low threshold value THe_L and the high threshold value THe_H which are set to the second threshold value THe in steps S314 and S316 are illustrated in FIG. 12. Both of the low threshold value THe_L and the high threshold value THe_H are set according to target pixel data Dn which is image data of a target pixel. In the example illustrated in FIG. 12, the low threshold value THe_L is set to −96 regardless of the target pixel data Dn, and the high threshold value THe_H is set to a positive value which increases along with the target pixel data Dn. The low threshold value THe_L and the high threshold value THe_H are stored in the error diffusion threshold value table 62 which is illustrated in FIG. 1.

If the result value Result [PT] is a value 1, in the first determination process, it denotes that image data which is a gradation value of the pixel PT is a threshold value THn_d or more of a corresponding position (ym, xm) of the dither mask 61. That is, it means that a condition for forming a dot in the pixel is established, when being accordance with the dither mask 61. Therefore, in this case, in the determination of the error diffusion which will be described later, a value of the threshold value THe is set to be small so that a dot is easily formed, and if not, the value of the threshold value THe is set to be large so that a dot is not easily formed.

After setting the threshold value THe which is used in the error diffusion, a process of obtaining correction image data data X [PT] is performed by adding ¼ of the density error ed[Bny, Bnx] of the block to the image data data[PT] of the pixel PT (step S317). The density error ed[Bny, Bnx] of a block denotes a total sum of error which is diffused from a block which is subjected to the half toning process by that time, and ¼ thereof is distributed to each pixel. Thereafter, whether or not the correction image data data X [PT] is the threshold value THe or more is determined (step S318). When the correction image data data X [PT] is the threshold value THe or more, it is determined that a dot is formed in the pixel (step S320). Specifically, a value 1 is set to the output buffer OUT [PT]. In step S318, when it is determined that the correction image data data X [PT] is not the threshold value THe or more, it is determined that a dot is not formed in the pixel, and the process in step S320 is not performed.

Thereafter, whether or not the above described processes are performed with respect to the entire pixel PT is determined (step S322), and the above described processes are repeatedly performed until a process with respect to the last pixel (PT=4) is finished. When processes with respect to the entire pixel are finished (Yes in step S322), the error calculation process (step S340), and the error diffusion process (step S350) which are described in FIG. 9 are performed, and the second determination process is finished.

### Effect of Modification Example 1

According to the above described modification example, the following effects are obtained.

(a) Since it is possible to freely set the threshold value THe using the error diffusion method using a comparison result with a threshold value of the dither mask 61, it is possible to freely set a gradation range, and a degree of proportion in which a process using the dither method is performed, and a gradation range, and a degree of proportion in which a process using the error diffusion method is performed using a combination of the dither method and the error diffusion method, that is, according to a gradation value of a pixel to be processed.

(b) Since the low level threshold value THe_L is set to a minus value, when a gradation value of a pixel which is being determined is larger than the threshold value THn_d of the dither mask in the first determination process, a dot is formed according to a determination in the error diffusion. Accordingly, it is possible to execute a dot arrangement which reflects the characteristics of the dither mask 61.

(c) In addition to that, when errors are further accumulated, a dot is formed according to a determination using the error diffusion method. Accordingly, when it is not determined that a dot is formed for a distribution of a gradation value of the dither mask at a portion in which a thin line is drawn in an image, or the like, for example, it is possible to form a necessary dot using the error diffusion method.

(d) Since the error diffusion process is performed in a unit of block, it is possible to reduce a calculation process of error diffusion, and to make a processing time short.

In above described modification example 1, as illustrated in FIG. 12, the low level threshold value THe_L is set to a minus constant value, and the high level threshold value THe_H is set to a value which gradually increases along with the pixel data Dn. Separately from this, as illustrated in FIG. 13, both of the low level threshold value THe_L and the high level threshold value THe_H may be set so as to gradually increase. In the example illustrated in FIG. 13, the low level threshold value THe_L is set so as to have a minus value in a region in which the pixel data Dn is low. By doing so, it becomes a dot arrangement which is close to a result of the dither method in a region in which a gradation value is low, and becomes a dot arrangement which is close to a result of the error diffusion method in a region in which a gradation value is high.

### B. Second Embodiment

Subsequently, a second embodiment of the invention will be described. The second embodiment is different from the first embodiment in the following points.

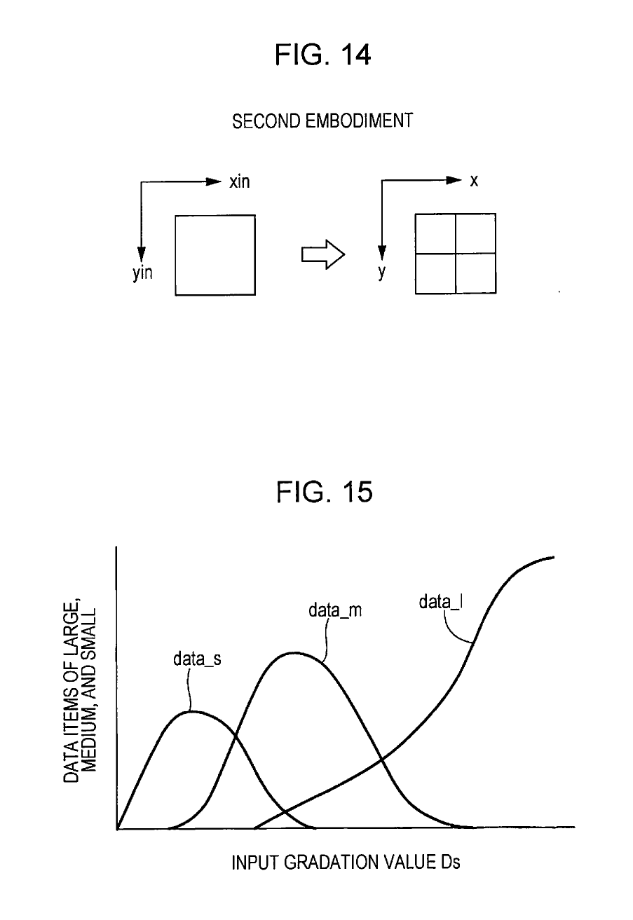

(a) As illustrated in FIG. 14, one pixel in an image corresponds to four pixels (2×2) of an image which is printed. Specifically, a resolution of an image which is going to be printed is 360 dpi in both of the x direction and the y direction; however, in contrast to this, a resolution of an image which is printed are 720 dpi in both of the x direction and the y direction.

(b) Since there are three types dots of small, medium, and large which can be formed on the printing medium P using the printing head 90, it is possible to express four gradations of a “large dot”, a “medium dot”, a “small dot”, and “no dot” per one pixel.

Since a resolution is different on an input side and on an output side, when being viewed by setting a block as a unit, it is assumed that there also are four pixels with the same gradation value on the input side in accordance with the output side. When a process is performed with respect to one block, similarly to that in the first embodiment, the same processes are sequentially repeated for four times from a pixel on the upper left side to a pixel on the lower right side.

According to the second embodiment, the printing process (FIG. 2), and the half toning process (FIG. 3) are performed, similarly to the first embodiment. In the halftoning process, similarly to the first embodiment, the first and second determination processes are performed; however, a pixel of an image to be processed is specified in the processing target specifying process (step S134 in FIG. 3), a position of a threshold value of the dither mask which is used in the first determination process is specified, and a process of obtaining dot data items of large, medium, and small from an input gradation value Ds of the pixel is performed prior to the determination processes. An image of the process is illustrated in FIG. 15. According to the second embodiment, when the input gradation value Ds is provided to each pixel, first, the gradation value Ds is converted so as to have a proportion which can be executed using each dot of large, medium, and small.

As illustrated in FIG. 15, at a position at which the input gradation value Ds is close to zero, only a small dot is formed, and a proportion of forming the small dot increases along with an increase of the input gradation value Ds. Here, the proportion of forming a dot denotes a percentage of the number of dots Nd which are formed in a predetermined number of printing pixels Ng (100×Nd/Ng) when the same input gradation value Ds is continued, that is, in a case of solid printing. When the input gradation value Ds reaches a first gradation value which is a predetermined gradation value, forming of a medium dot is started, and gradually increases, and a proportion of forming the small dot decreases in accordance with this. Similarly, when the input gradation value Ds reaches a second gradation value which is larger than the first gradation value, forming of a large dot is started, and gradually increases, and a proportion of forming the medium dot decreases in accordance with this. The proportion of forming the small dot is denoted by data-s, the proportion of forming the medium dot is denoted by data-m, and the proportion of forming the large dot is denoted by data-l, respectively, and a value which is obtained by adding all of the values data_s, data_m, and data_l is denoted by a total value data_t. The relationship which denotes the proportion of forming the small, medium, and large dots with respect to the input gradation value Ds is stored in the EEPROM 60 as a LUT.

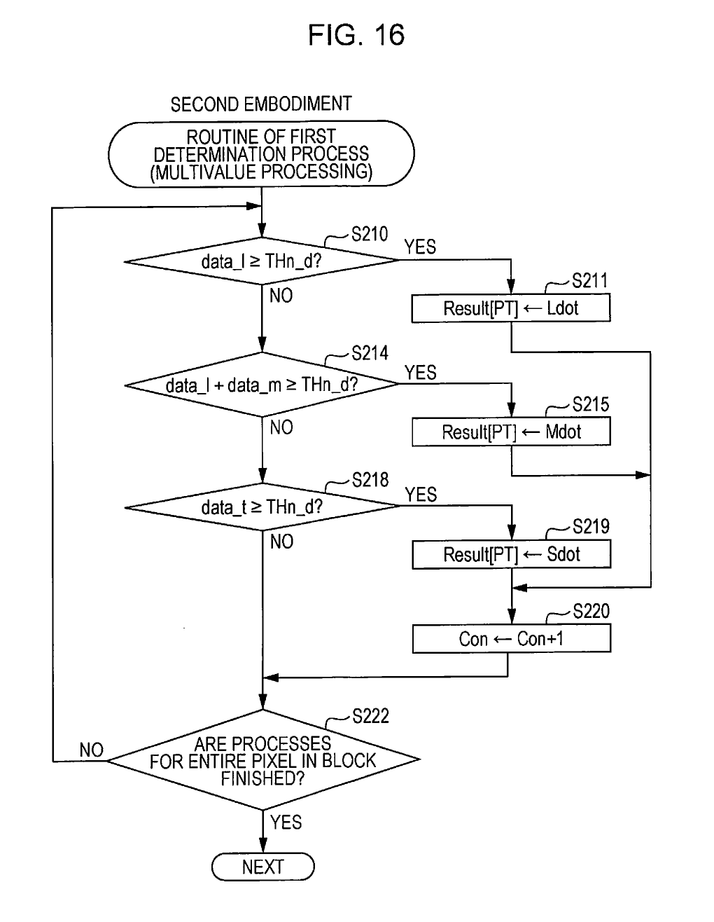

In the processing target specifying process (step S134), the input gradation value Ds is read, and the data items of data_s, data_m, and data_l which denote rates of forming the small, medium, and large dots are obtained with reference to the LUT which is stored in the EEPROM. In addition to that, the routine of the first determination process in the second embodiment which is illustrated in FIG. 16 is executed. The process is performed in each block, similarly to that in the first embodiment. As illustrated in FIG. 14, first, the CPU 40 determines whether or not the data_l which denotes a proportion of forming a large dot is the threshold value THn_d or more at a corresponding position of the dither mask 61 with respect to one pixel which is included in one block (step S210).

When the data_l is the threshold value THn_d or more, a value Ldot which denotes that a large dot is formed is input to the result value Result [PT] of the pixel PT (step S211). On the other hand, when the data_l is less than the threshold value THn_d, subsequently, whether or not a total value of the data_l and the data_m is the same threshold value THn_d or more is determined (step S214). When the data_l and the data m are the threshold value THn_d or more, a value Mdot which denotes that a medium dot is formed is input to the result value Result [PT] of the pixel PT (step S215).

In addition, when the data_l and the data_m are less than the threshold value THn_d, subsequently, whether or not the total value data t is the same threshold value THn_d or more is determined (step S218). When the data_t is the threshold value THn_d or more, a value Sdot which denotes that a small dot is formed is input to the result value Result [PT] of the pixel PT (step S219). When any one of determination results in the above described steps S210, S214, and S218 becomes “Yes”, and any one of Ldot, Mdot, and Sdot is input to the result value Result [PT], it is assumed that a condition for forming a dot is established, and the dot forming counter Con is increased by a value 1 (step S220).

In the above described process, whether the gradation value Ds of an input pixel is large enough so that a large dot is formed is determined by being compared with the threshold value THn_d of the dither mask, and the comparison with the same threshold value THn_d is repeated while sequentially adding data of a small dot. This is a determination method which is referred to as a so-called continuous dithering. An idea of the continuous dithering is that in which, when a size of a gradation value of the pixel is not enough to form a large dot, whether or not it is a size enough for forming a medium dot is determined by adding data which denotes forming rates of large and medium dots, and when a size of a gradation value of the pixel is not enough to form a medium dot, whether or not it is a size enough for forming a small dot is determined using a total value of forming rates of large, medium, and small dots. In this manner, it is possible to appropriately arrange large, medium, and small dots only by preparing one dither mask.

When the above described processes are finished, whether or not determinations on all of pixels in the block are finished is determined (step S222), and the above described processes (steps S210 to S222) are repeated until the determinations on four pixels are finished. The input gradation value Ds has the same value even when the input pixel PT is sequentially processed; however, a position of obtaining a threshold value from the dither mask 61 is moved, a different threshold value THn_d is extracted, and is provided to the determinations in steps S210, S214 and S218.

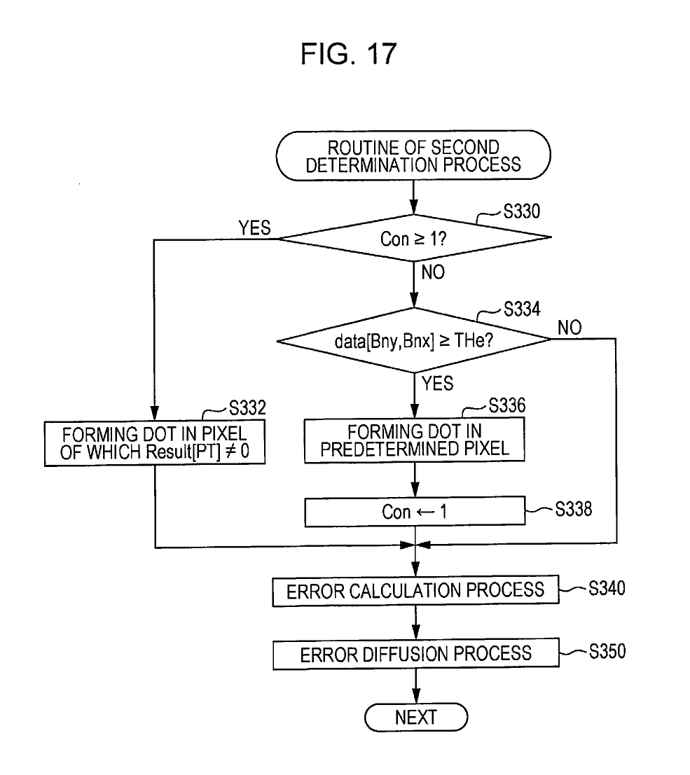

When the routine of the first determination process which is illustrated in FIG. 16 is finished, subsequently, a routine of the second determination process which is illustrated in FIG. 17 is executed. When the process is started, first, the CPU 40 determines whether or not the counter Con is a value 1 or more (step S330). The counter Con reflects the number of dots which are formed in the first determination process (FIG. 16) in the block which is currently processed. Accordingly, when the determination result in step S330 is “Yes”, since it is determined that at least one dot is formed in the block using the first determination process, the process proceeds to step S332, and a process of forming a dot in a pixel of which result value Result≠0 is performed. The formed dot is a large dot in a pixel PT of which the result value Result [PT] is Ldot, is a medium dot in a pixel PT of which the result value Result [PT] is Mdot, and is a small dot in a pixel PT of which the result value Result [PT] is Sdot.

On the other hand, when the counter Con is not a value 1 or more, since the determination on whether or not to form a dot in the block was not made in the first determination process, subsequently, whether or not the image data data[Bny, Bnx] of the entire block is the threshold value THe or more, which is prepared for the error diffusion method, is determined (step S334). When the image data data[Bny, Bnx] of the entire block is the threshold value THe or more, a dot is formed in a predetermined pixel (step S336). These processes correspond to processes in steps S306 and S308 in the routine of the second determination process according to the first embodiment (FIG. 9). As described above, the data[Bny, Bnx] reflects a density error which is diffused from the peripheral block, since the data[Bny, Bnx] is calculated as data[Bny, Bnx]=data[y, x]+data[y, x+1]+data[y+1, x]+data[y+1, x+1]+ed[Bny, Bnx].

A predetermined pixel in which a pixel is formed may be set to the pixel (PT=1) on the upper left side in the block, similarly to that in the first embodiment. Originally, a dot may be formed in a pixel of which gradation data is largest among four pixels in the block, may be formed in a pixel which correspond to a position at which a threshold value of a corresponding dither mask is smallest, or it is allowable to randomly determine a pixel in which a dot is formed. In addition, according to the embodiment, a dot which is formed is set to a small dot. The reason for this is that, according to the first determination process, originally, since there is a block in which a dot is not formed, and in many cases, it is enough for a pixel which is formed using a determination in the entire block to express minimum density. After forming a dot in a predetermined pixel, a value 1 is set to the counter Con in preparation for an error calculation which will be described later (step S338).

After finishing the above described processes, similarly to the first embodiment, the error calculation process (step S340), and the error diffusion process (step S350) are performed. The error calculation process is performed after the following processes of

(a) the process in step S332 in which a dot is formed in a pixel of which the result value Result [PT]≠0,

(b) the processes in steps S336 and S338 in which a dot is formed in a predetermined pixel, or

(c) the process in step S334 in which a dot is not formed by determining that the total sum of image data in a block, that is, data[Bny, Bnx] is less than the threshold value THe in the error diffusion method.

In the error calculation process (step S340), the density error ed[Bny, Bnx] which occurs in a processed block is obtained. The density error ed[Bny, Bnx] is obtained using the following expression.

ed[Bny,Bnx]=data[Bny,Bnx]−Con·ONv

The ONv is an on-value which is described in the first embodiment. A value of the counter Con reflects the number of dots which are set to be formed in a block. Accordingly, the density error ed[Bny, Bnx] of a processed block becomes a value which is obtained by subtracting a multiplied value of Con which is the number of dots formed in a block and an on-value from total sum data[Bny, Bnx] of image data in the block in a case of (a), becomes a value which is obtained by subtracting an on-value of one dot which is formed in a block from the total sum data[Bny, Bnx] of image data in the block in a case of (b), and becomes the total sum data[Bny, Bnx] of image data in the block in a case of (c). In the cases of (a) and (c), there is a case in which an operation result becomes a minus value, and in this case, diffusing of a minus error to the peripheral pixel is the same as that in the first embodiment.

When density which is executed using dots which are formed in a block is upper than that of image data of the entire block, a density error becomes a minus value. When density which is executed using dots which are formed in a block is lower than that of image data of the entire block, a density error becomes a plus value. In this case, density which is executed in the block is different depending on which dot among large, medium, and small dots is formed; however, according to the second embodiment an on-value ONv per one dot is set to a constant value, and a calculation thereof is simplified. Originally, density which is executed in a block may be calculated in detail by making the on-value ONv different depending on which dot among large, medium, and small dots is formed.

After obtaining the density error ed[Bny, Bnx] in this manner, the error diffusion process (step S350) in which the density error ed[Bny, Bnx] is distributed to the adjacent block is performed. The process in step S350 is the same as that in the first embodiment, descriptions thereof will be omitted.

According to the second embodiment which is described above, it is possible to perform processing of multivalue in a block, in addition to obtaining of the same effect as that in the first embodiment, and to form an image which is fine, and with high quality. In addition, it is possible to reproduce a thin line using a small dot while forming a high quality image using dots of large, medium, and small, and to make a high image quality using multivalue processing compatible with reproducing of a thin line.

### Modification Example 2

In the above described embodiment, as a gradation value of a pixel, a processing target gradation data Dn of the pixel is used as is, in the first determination process; however, a determination may be made after obtaining correction image data by multiplying a coefficient k to the image data in the first determination process in advance. In the first embodiment, in step S205 in the routine of the first determination process which is illustrated in FIG. 5, correction pixel data′[PT] is obtained as data′[PT]←data[PT]×k, instead of a determination of data[PT]≧THn_d?, and make a determination of data′[PT]≧THn_d?. In addition, in the second embodiment, in the first determination process in FIG. 16, rates for forming small, medium, and large dots are obtained after multiplying the coefficient k to the image data Dn before obtaining data_s, data_m, and data_l which are rates for forming the small, medium, and large dots.

When a coefficient k in a region with low pixel data, that is, a highlight portion is set to a value which is smaller than 1.0, it is possible to lower a proportion in which a dot is formed in the first determination process (dither method), and to supplement the lowered proportion in forming of dots using the second determination process (error diffusion method). That is, in the first determination process, a proportion in which it is determined that a gradation value of a pixel as a processing target satisfies a predetermined condition (data[PT]≧THn_d) is set to a proportion lower than a proportion in which a dot is finally formed in pixel data data[PT] of the pixel. For this reason, it is possible to raise a proportion of dot generation due to error diffusion at a highlight portion.

### Modification Example 3

In the above described embodiment, a determination result is stored in the result value Result [PT] in the first determination process, and a final dot generation is determined in the second determination process. In contrast to this, in the first embodiment, or the like, a determination of forming a dot in the pixel may be made simultaneously with setting of a value 1 in the result value Result [PT], in the first determination process (FIG. 5). That is, the process in step S304 in FIG. 9 may be performed in the first determination process (FIG. 5).

### Other Modification Examples

The invention can adopt various configurations other than the above described embodiments and modification examples. For example, as the first determination process, another determination process such as a density pattern method, an area gradation method, or the like, may be performed instead of the dither method. Alternatively, the number of pixels which are included in one block may be set to 2×1, 1×2, 3×2, 2×3, 3×3, and the like. A block which is formed of many more pixels may be used. Alternatively, a block is not necessarily limited to a rectangular shape, and may be a cross, a parallelogram in which one, or a plurality of pixels are shifted between vertical rasters, or the like. A shape of a block may be not limited to one type in one image.

In addition, when performing multivalue processing, a type of dot may be two types (multivalue processing of ternary processing or more), or may be four types or more. The multivalue processing may be executed by changing a size of small, medium, and large dots, and may be executed using a difference in density of a dot by preparing gradation ink. Alternatively, the multivalue processing may be executed by changing the number of times of dropping ink droplets on the same pixel. Ink droplets which repeatedly drop may be the same size, or may be a different size. Ink which forms a dot may be ink with different hue on the premise of multicolor printing, and may be single color ink on the premise of single color printing such as monochrome printing. In a case of a printing apparatus in which plurality of ink is used, the method of the invention may be applied to all of ink, or may be applied only to a part of ink.

The dither mask which is used in the first determination process has blue noise characteristics; however, the dither mask may have green noise characteristics, or may have other characteristics, for example, pink noise characteristics, or white noise characteristics. Alternatively, the dither mask may be a dot density-type dither mask, a Bayer-type dither mask in which regular dot arrangement is obtained, or a halftone dot-type dither mask. In addition, when a printing operation forms an image using reciprocating of the printing head 90, or using a plurality of passes, the dither mask may be a dither mask in which an arrangement of a threshold value is decided so that characteristics of dots which are formed using a forward movement of the printing head 90, and/or characteristics of dots which are formed using a return movement, in addition, characteristics of dots which are formed using reciprocating become specific noise characteristics.

In the above described embodiment, a dot which is formed as a result of the second determination process is set to one in a block; however, a plurality of dots, for example, two dots may be formed according to a size of the pixel data data[Bny, Bnx] of the entire block. In this case, the maximum number of dots which can be generated may not exceed ½ of the number of pixels which are included in the block. In this manner, it is possible to avoid excessive generating of dots using the second determination process. The second determination process is assumed to be a process used for generating a dot which is not easily generated in the first determination process, for example, a dot corresponding to an image with a thin line, and the reason for this is that, in such a case, it is preferable to suppress a proportion of dot forming in the second determination process.

The invention is not limited to the above described embodiments or examples, and modification examples, and can be executed in various configurations without departing from the scope of the invention. For example, technical characteristics in the embodiments, the examples, and the modification examples corresponding to technical characteristics in each embodiment which are described in the summary of the invention can be appropriately replaced or combined in order to solve a part, or all of the above described problems, or to achieve a part, or all of the above described effects. In addition, when the technical characteristics are not described as essential characteristics in the specification, the characteristics can be appropriately deleted.

What is claimed is:

1. A printing apparatus which prints an image by performing a half toning process, by setting a block which is formed of a plurality of pixels as a unit, the apparatus comprising:
a first determination unit which determines whether or not a gradation value of each of the plurality of pixels satisfies a predetermined condition;
a second determination unit which applies different conditions based on a determination result of the first determination unit, and determines whether or not to form a dot in at least one of the plurality of pixels;
an error calculation unit which performs a calculation of a gradation error which occurs due to a determination result of the second determination unit, and a distribution of the calculated error to an unprocessed pixel by setting the block as a unit; and
a dot forming unit which performs forming of dots using the determination result of the second determination unit.

2. The printing apparatus according to claim 1,
wherein, in a determination of whether or not the gradation value in the first determination unit satisfies a predetermined condition, when a value corresponding to a gradation value of each pixel in the block is larger than a first threshold value which is a threshold value of a position corresponding to a pixel position among threshold values which are provided as a dither mask, it is determined that the predetermined condition is satisfied.

3. The printing apparatus according to claim 1,
wherein, in the first determination unit, when a gradation value of at least one pixel in the block satisfies the predetermined condition, a dot corresponding to the pixel is formed without making the determination using the second determination unit.

4. The printing apparatus according to claim 3,
wherein, in the first determination unit, when it is determined that a gradation value of any pixel in the block does not satisfy the predetermined condition, the second determination unit determines whether or not to form a dot by comparing image data, which corresponds to a gradation value of a pixel in the block and which is correction image data that has received a distribution of the calculated error with a second threshold value which is a threshold value prepared for error diffusion.

5. The printing apparatus according to claim 1,
wherein a proportion in which it is determined that a predetermined condition is satisfied, in the first determination unit, is a proportion which is lower than a proportion in which a dot is finally formed in a gradation value of the pixel.

6. The printing apparatus according to claim 1,
wherein the second determination unit sets a proportion in which forming of a dot in a pixel in the block is determined to be less than a half of the number of pixels which belong to the block.

7. The printing apparatus according to claim 1,
wherein, when a gradation value of each of the pixels satisfies the predetermined condition, the second determination unit makes the determination by applying a condition in which it is easy to form a dot corresponding to the pixel, compared to a case in which the predetermined condition is not satisfied, and when a gradation value of each of the pixels does not satisfy the predetermined condition, the second determination unit makes the determination by applying a condition in which it is difficult to form a dot corresponding to the pixel compared to the case in which the predetermined condition is satisfied.

8. The printing apparatus according to claim 7,
wherein, when determining forming of a dot compared to a second threshold value which is a threshold value prepared for error diffusion, the second determination unit determines forming of the dot in any one of a pixel at a predetermined position in the block, a pixel which is randomly determined in the block, and a pixel at a position corresponding to a threshold value with a smallest value among threshold values which are provided in a dither mask, and correspond to pixel positions in the block.

9. The printing apparatus according to claim 2,
wherein, in the half toning process, multivalue processing of ternary processing or more is performed based on a determination result of the first determination unit.

10. The printing apparatus according to claim 9,
wherein the first determination unit determines multivalue processing of ternary processing or more by continuously using a plurality of threshold values corresponding to a pixel in the block of the dither mask.

11. The printing apparatus according to claim 9,
wherein, in the halftoning process, the second determination unit determines whether or not to form a dot with respect to a dot with low density.

12. A printing method in which an image is subjected to a halftoning process by setting a block, which is formed of a plurality of pixels as a unit, and is printed, the method comprising:
making a first determination which is a determination as to whether or not a gradation value of each of the plurality of pixels satisfies a predetermined condition;
making a second determination in which different conditions based on a determination result of the first determination are applied, and whether or not to form a dot in at least one of the plurality of pixels is determined;
performing a calculation of a gradation error which occurs due to a determination result of the second determination, and a distribution of the calculated error to an unprocessed pixel by setting the block as a unit; and
performing forming of a dot using a determination result of the second determination.

13. An image processing apparatus in which an image is subjected to a halftoning process by setting a block which is formed of a plurality of pixels as a unit, the apparatus comprising:
a first determination unit which determines whether or not a gradation value of each of the plurality of pixels satisfies a predetermined condition;
a second determination unit which applies different conditions based on a determination result of the first determination unit, and determines whether or not to form a dot in at least one of the plurality of pixels; and
an error calculation unit which performs a calculation of a gradation error which occurs due to a determination result of the second determination unit, and a distribution of the calculated error to an unprocessed pixel by setting the block as a unit.

14. A program in which an image is subjected to a halftoning process by setting a block which is formed of a plurality of pixel as a unit, the program causing a computer to execute:
a function of making a first determination which is a determination as to whether or not a gradation value of each of the plurality of pixels satisfies a predetermined condition;
a function of making a second determination in which different conditions based on a determination result of the first determination are applied, and whether or not to form a dot in at least one of the plurality of pixels is determined; and
a function of performing a calculation of a gradation error which occurs due to a determination result of the second determination, and performing a distribution of the calculated error to an unprocessed pixel by setting the block as a unit.
